(19) United States
(12) Patent Application Publication
(10) Pub. No.: US 2002/0017548 A1
(43) Pub. Date: Feb. 14, 2002

(54) Fastener driving system and magazine assembly therefor

(76) Inventors: David B. Jalbert, Coventry, RI (US); Jeffrey Lundgren, North Providence, RI (US); Daniel B. Friebe, Paramus, NJ (US)

Correspondence Address: Pillsbury Winthrop LLP, Intellectual Property Group, Ninth Floor, 1100 New York Avenue, NW., Washington, DC, 20005-3918, US

(21) Appl. No.: 09/855,749

(22) Filed: May 16, 2001

Related U.S. Application Data
(60) Provisional application No. 60/204,803, filed on May 16, 2000.

(51) Int. Cl. B25C 5/02

(52) U.S. Cl. 227/136; 227/137

(57) ABSTRACT

The present application related to a fastener driving system and, more particularly, to a magazine assembly for use with a fastener driving system.

The present Application claims priority to U.S. Provisional Application of Jalbert, Ser. No. 60/204,803, filed May 16, 2000, the entirety of which is hereby incorporated into the present application by reference.

### FIELD OF THE INVENTION

The present invention relates to a fastener driving system and, more particularly, to a magazine assembly for use with a fastener driving system.

### BACKGROUND OF THE INVENTION

Conventional fastener driving devices, such as pneumatic, internal combustion, other types of nail driving devices, carry a magazine structure fixedly mounted to the housing of the device. Normally, the magazine structure has a cover or door that closes the magazine interior to retain the fasteners therein and that opens to permit loading of addition fasteners.

Typically, the fasteners loaded in the magazine interior come in two forms:

pre-wound coils or straight fastener sticks. Pre-wound coils have a plurality of fasteners secured to a flexible collation structure. For nails, the collation structure is often a pair of elongated and somewhat flexible metal wires with the nails spot-welded at the shanks thereof to the wires. The coil is wound up and bundled or held together by an elastic or rubber band. Straight fastener sticks also have a plurality of fasteners secured directly together or secured to a collation structure. For nails, the collation structure of a fastener stick is often a pair of elongated and somewhat rigid metal wires with the nails spot-welded to the wires.

It is also known in the art to provide these fasteners pre-packaged in a disposable container that loads into the magazine assembly of the device. An example of such a disposable container is discussed in U.S. Pat. No. 3,558,031. The disclosure of the '031 patent mentions that the magazine assembly thereof may be used with a removable container in which the nails are carried. The nails are dispensed from a chute that mounts directly to the nose assembly of the device. However, the removable container of the '031 patent has a number of drawbacks. For example, the container is difficult to mount on the device. Further, the container is not disclosed as being transparent or the like and thus the user cannot readily visually verify the number of nails remaining within the container.

### SUMMARY OF THE INVENTION

It is one object of the present invention to provide an easy loading magazine assembly for use in conjunction with a fastener driving device. To achieve this object, one aspect of the present invention provides a fastener driving system for driving fasteners into a workpiece. The system comprises a fastener magazine assembly and a fastener driving device. The magazine assembly comprises a collation carrying structure having a post structure providing a first surface of the carrying structure with a fastener device mounting bore. The post structure provides a second surface of the carrying structure opposite the first surface with a coil locating surface. The collation carrying structure may take any shape, form, or configuration and is not to be limited to the enclosed container disclosed herein. The fastener collation assembly also comprises a plurality of fasteners releasably interconnected together by collation structure. The collation structure may have any construction including, but not limited to, metal wires and molded plastic. The collation assembly is wound in an annular coil surrounding the coil locating surface of the post structure of the carrying structure with a lead end portion of the collation assembly positioned to be dispensed from the carrying structure.

The fastener driving device comprises a housing including an outer shell and a nose assembly. The nose assembly provides a fastener drive track constructed and arranged to receive a lead fastener from the collation assembly. The housing has a projection that is removably receivable within the mounting bore of the collation carrying structure in a magazine supporting relationship. In this magazine supporting relationship, the projection and the bore cooperate to removably support the carrying structure in an operative position to enable a lead fastener carried on the lead end portion of the fastener collation assembly to be disposed in the drive track and to enable the magazine assembly to be removed for fastener replenishment. In this first aspect of the invention, the location of the projection may be anywhere on the driving device. Further, the projection may function to support the magazine assembly alone, or in cooperation with one or more additional structures.

The fastener driving device also comprises a driver member mounted for movement along the drive track through a drive stroke wherein the driver member impacts the lead fastener received in the drive track and drives the lead fastener outwardly from the drive track into the workpiece and a return stroke opposite the drive stroke. A power drive assembly is operatively connected to the driver member, and moves the driver member under power through the drive stroke thereof. The power drive assembly may be pneumatic, electric, fluid driven, internal combustion, or explosive cartridge driven. The driving device further comprises a feed mechanism having feeding structure constructed and arranged to engage the collation assembly. The feeding mechanism is constructed and arranged to move the feeding structure so as to move the collation assembly in a feeding direction to feed a subsequent lead fastener into the drive track after the driving member has impacted and driven the aforesaid lead fastener into the workpiece. The construction of the feeding mechanism and the manner in which it operates is not critical to this aspect of the invention and thus this aspect of the invention is not limited to any particular type of feeding mechanism.

A related aspect of the invention provides a magazine assembly that has a post structure defining a bore for receiving the projection on a fastener driving device.

Also for achieving the aforementioned object of the present invention, another aspect of the present invention provides another fastener driving system for driving fasteners into a workpiece. The system comprises a fastener magazine assembly and a fastener driving device. The magazine assembly comprises a collation carrying structure and a fastener collation assembly comprising a plurality of fasteners releasably interconnected together by collation structure. The fastener collation assembly is carried by the carrying structure with a lead end portion of the collation assembly positioned to enable the collation assembly to be dispensed from the carrying structure.

In accordance with this aspect of the invention, the fastener collation assembly may be arranged in any configuration in the carrying structure, including, but not limited to arranging the collation assembly in a coiled or zig-zag format. The fastener driving device comprises a housing including an outer shell and a nose assembly, a first carrying structure engaging member having a first carrying structure engaging surface, and a second carrying structure engaging member having a second carrying structure engaging surface. The first and second carrying structure engaging members may have any configuration and are not limited to the projection/bore arrangements illustrated herein. The first and second carrying structure engaging members are movable relative to one another between a supporting position and a releasing position. In the supporting position, the respective first and second carrying structure engaging surfaces of the carrying structure engaging members removably engage opposing sides of the carrying structure between the engaging surfaces thereof in a sandwiched magazine supporting relationship wherein the first and second carrying structure engaging members cooperate to removably support the carrying structure in an operative position to enable a lead fastener carried on the lead end portion of the fastener collation assembly to be disposed in the drive track of the nose assembly. In the releasing position, the first and second carrying structure engaging members are moved out of the supporting position to enable the magazine assembly to be removed for fastener replenishment.

The fastener driving device in the system according to this aspect of the invention also comprises a drive member and a power drive assembly for driving the lead fastener outwardly from the drive track and into the workpiece. As with the previous aspect, the power drive assembly may be of any suitable construction. The fastener driving device also comprises a feeding mechanism that may be of any suitable construction.

It is a farther object of the present invention to provide a collation container that enables the user to visually verify an amount of fasteners remaining in the container. To achieve this further object, yet another aspect of the present invention provides a fastener driving system comprising a magazine assembly and a fastener driving device. The magazine assembly comprises a first container portion and a second container portion that are coupled together to form a collation container enclosing an interior annular collation receiving space. The collation container has a collation viewing portion thereof formed from a light permeable material through which a user can view the interior annular collation receiving space. The light permeable material may be transparent or translucent. The collation container has an exit opening that opens outwardly from the collation receiving space. A fastener collation assembly comprising a plurality of fasteners releasably interconnected together by collation structure is disposed in the collation receiving space of the container. The collation assembly is positioned with respect to the collation viewing portion of the container such that the user can view the collation assembly to visually ascertain an amount of the collation assembly remaining in the container.

The fastener driving device comprises a housing including an outer shell and a nose assembly, and a container supporting structure. With respect to this aspect of the invention, the container supporting structure may be any type of structure capable of supporting a container and is not to be limited to the type of container supporting arrangement disclosed herein. The collation container is removably engageable with the container supporting structure in a cooperating magazine supporting relationship wherein the supporting structure and the container cooperate to removably support the container in an operative position to enable a lead fastener carried on the lead end portion of the fastener collation assembly to be disposed in the drive track and to enable the magazine assembly to be removed and replaced by a similar magazine assembly when the fasteners in the container are depleted. The fastener driving device further comprises a driver member and a power drive assembly of any type for driving the lead fastener into the workpiece and a feed mechanism of any type for feeding the lead fastener into the drive track.

A related aspect of the invention provides a magazine assembly having the collation viewing portion as mentioned above.

Other objects, features, and advantages of the present invention will become apparent from the following detailed description, the accompanying drawings, and the appended claims.

### BRIEF DESCRIPTIONS OF THE DRAWINGS

FIG. 1 is a perspective view of a fastener driving device with a movable collation carrying structure engaging member thereof moved to a releasing position enabling a fastener magazine assembly to be mounted in an operative position to the driving device;

FIG. 2 is a view similar to FIG. 1 showing the nose assembly and the collation carrying structure engaging members in closer detail with the movable collation carrying structure engaging structure in the releasing position thereof;

FIG. 3 is a view similar to FIG. 2 with a collation carrying structure mounted to the movable collation carrying structure engaging member in the releasing position thereof;

FIG. 4 is a view similar to FIG. 3 with the movable collation carrying structure moved to a supporting position and a door of the nose assembly in an open position;

FIG. 5 is a view similar to FIG. 4 with the movable collation carrying structure moved to the supporting position thereof and the door of the nose assembly in the closed position thereof and;

FIG. 6 is a cross-sectional view of the nose assembly with the collation carrying structure mounted in an operative position, the cross-section being taken vertically along a longitudinal axis of the nose assembly.

### DETAILED DESCRIPTION OF THE INVENTION

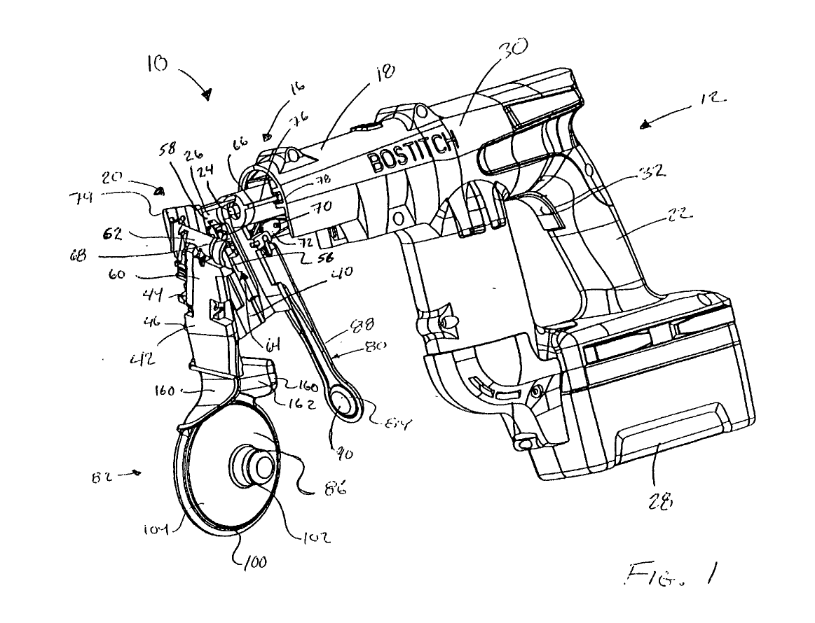

FIG. 1 is a perspective view of a fastener driving system, generally indicated at 10. The system 10 generally comprises a fastener driving device, generally indicated at 12, and a removable fastener magazine assembly, generally indicated at 14.

The fastener driving device 12 comprises a housing 16 having an outer shell 18 and a nose assembly, generally indicated at 20, at a forward end of the shell 18. The shell 18 provides a manually engageable handle 22 for facilitating manual handling of the device 14. The nose assembly 20 is removably mounted to the shell 18, although it may be fixedly mounted to the shell 18 without affecting the principles of the present invention. The shell 18 houses a power drive assembly (not shown) and a driver member 24. The driver member 24 is mounted for movement along a drive track 26 provided by the nose assembly 20 through a drive stroke wherein the member 24 impacts a lead fastener received in the track 28 and drives the lead fastener outwardly from the track 26 into a workpiece and a return stroke opposite the drive stroke. The power drive assembly is operatively connected to the driver member 24 and is constructed and arranged to move the driver member 24 under power through the drive stroke thereof.

The power drive assembly may be of any type suitable for moving the driving member 24 through the drive stroke thereof. For example, the device 12 illustrated is of the electropneumatic multi-stroke type disclosed in the following U.S. patent applications, Ser. No. 09/398,456, (filed Sep. 17, 1999), Ser. No. 09/396,476 (filed Sep. 15, 1999), Ser. No. 09/636,080 (filed Aug. 11, 2000), Ser. No. 09/635,779 (filed Aug. 11, 2000), Ser. No. 09/635,758 (filed Aug. 11, 2000), Ser. No. 09/635,757 (filed Aug. 11, 2000), and Ser. No. 09/635,079 (filed Aug. 11, 2000), the entirety of each of which is hereby incorporated into the present application in its entirety. In the illustrated embodiment, reference numeral 28 indicates the removable battery pack for powering the device 12 and reference numeral 30 indicates the portion of the shell 18 that houses the operative components of the power drive assembly. Alternatively, the power drive assembly may be a single stroke type device that is pneumatically powered, internal combustion powered, or powered by single shot explosive cartridges. A trigger 32 or any other suitable mechanism for actuating the power drive assembly and affecting the drive stroke of the driver member 24 is provided on the shell 18 at the handle 22 thereof.

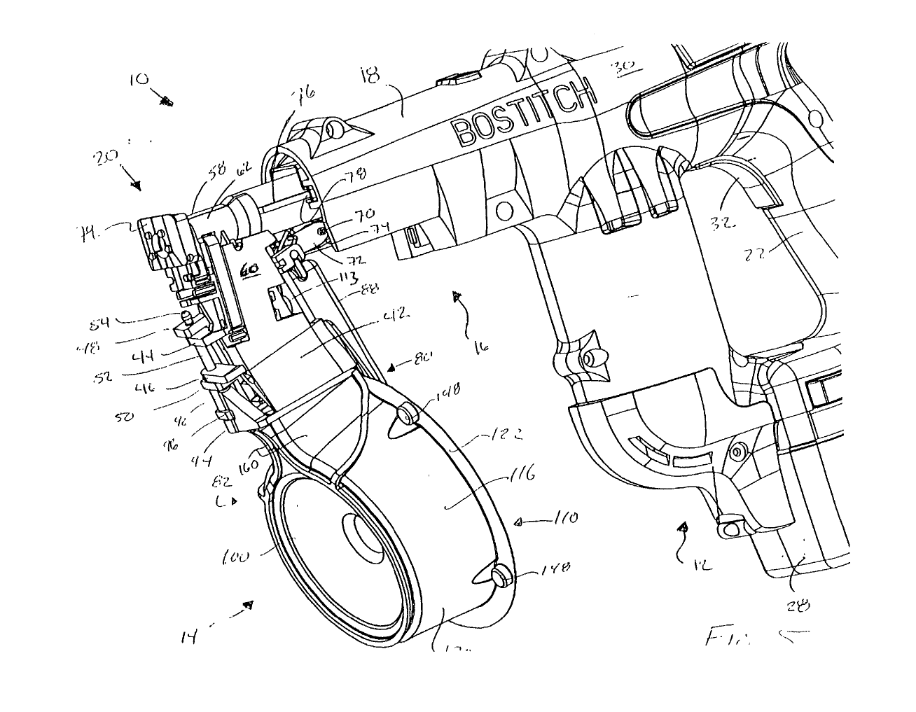

The nose assembly 20 comprises a fixed track defining structure 40 and a movable track defining structure 42 pivotally connected to the fixed structure 40. The movable track defining structure 42 pivots between an open position as shown in FIGS. 1-4 and a closed position as shown in FIG. 5. Specifically, the movable structure 42 has a pair of flanges 44, 46 with pivot pin receiving apertures formed therethrough and the fixed structure 40 also has a pair of flanges 48, 50 with pivot pin receiving openings formed therethrough. The movable structure 42 is pivotally connected to the fixed structure 40 by aligning the pivot pin receiving openings of flanges 44, 46, 48, 50 and inserting an elongated pivot pin 52 therethrough. An enlarged head 54 is provided on the upper end of the pin 52 to prevent withdrawal of the pin 52 in a downward direction.

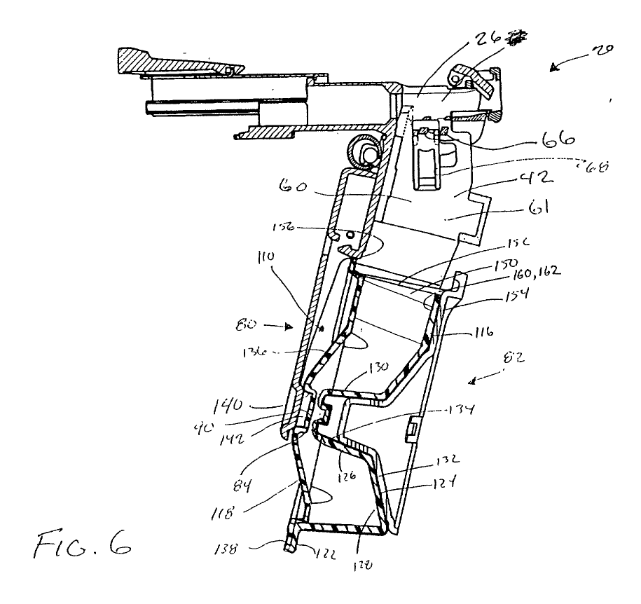

The fixed track defining structure 40 has a guide track defining portion 56 and a drive track defining portion 58. Likewise, the movable track defining structure 42 has a guide track defining portion 60 and a drive track defining portion 62. When the movable structure 42 is moved to the closed position thereof as shown in FIG. 5, the interior surfaces of the drive track defining portions 58, 62 cooperate to define the aforesaid drive track 26 and the interior surfaces of the guide track defining portions 56, 60 cooperate in spaced apart relation to define a guide track 61 (see FIG. 6) that opens to the drive track 26. During operation, the guide track 61 receives nails from the magazine assembly 14 and guides them into the drive track 26 for impact and outward driving therefrom by the driver member 24.

A feeding mechanism, generally indicated at 64, carried by the nose assembly 20 has a collation feeding structure 66 extending through an opening 68 at the interior surface of the guide track defining portion 58 of the fixed structure 40. The feeding mechanism 64 also has a roller (not shown) that rollingly rides along a cam surface 74 defined within the housing shell 18. The roller and the feeding structure 68 are interconnected by a rigid arm 72. More specifically, the roller is rotatably mounted to the arm 72 by axle pin 70 and the feeding structure 66 is pivotably connected to the opposite end of the arm 72 by a similar axle pin or the like. The feeding structure 66 moves generally linearly in a feeding direction oriented in the same general direction as the feed track and generally perpendicular to the drive track 26. The manner in which the feeding structure 66 affects collation feeding is described in further detail herein below.

The nose assembly 20 is mounted to move in a generally rectilinear manner with respect to the shell 18. Specifically, the nose assembly 20 has a pair of laterally extending wings 76 that are received within a pair of longitudinally extending tracks 78, provided on the interior of the shell 18. The wings 76 and tracks 78 cooperate to guide the nose assembly 20 for its rectilinear movement relative to the shell 18. A spring (not shown) biases the nose assembly 20 forwardly to its forwardmost position. During operation, the user presses the workpiece contact member 79 against the workpiece and pushes forwardly on the handle 22. This moves the shell 18 forwardly relative to the nose assembly 20. As the shell 18 moves forwardly, the roller of the nose assembly 20 rides upwardly (as viewed in the Figures) along the sloped camming surface 74. The slope of the camming surface 74 causes the arm 72 to pivot so as to move the feeding structure 66 downwardly along the guide track 61 to a feeding position underneath a subsequent lead fastener disposed therein. The feeding structure 66 rides over the exterior surface of the subsequent fastener in the guide track 61 in a camming manner until it passes the subsequent fastener and resiliently moves under spring biasing further into the guide track into the feeding position underneath the shank of the subsequent fastener.

Also, when the nose assembly 20 has reached its rearwardmost position, it activates an electronic or mechanical contact switch. Activation of this switch permits the power drive assembly to be operated for affecting the drive stroke of the driver member 24 wherein the lead fastener is driven into the workpiece. When the workpiece contact structure 79 is disengaged from the workpiece, the spring mentioned above moves the nose assembly 20 to its forwardmost position. During this movement, the roller rides back down the camming surface 74 and a torsion spring (not shown) connected to arm 72 moves the feeding structure 66 upwardly along the guide track 61 into in the feeding direction thereof to advance the subsequent fastener into the drive track 26 for driving therefrom as the lead fastener.

The housing 16, and in particular the nose assembly 20, provides a pair of carrying structure engaging members 80, 82 that each provide respective carrying structure engaging surfaces 84, 86. Engaging member 80 has an elongated rigid arm 88 depending downwardly from the nose assembly 20. The upper end of arm 88 is fixed to the nose assembly 20 by fasteners, integral molding, adhesion, or any other suitable arrangement. The lower end of arm 82 provides a generally circular and rounded protrusion 90 that provides carrying structure engaging surface 84.

Carrying structure engaging member 82 has a pair of flanges 92, 94 that have pivot pin receiving openings formed therethrough. Engaging member 82 is pivotally mounted to the fixed track defining structure 40 (or any other suitable structure on the nose assembly 20 and/or housing 16) by aligning the openings on flanges 92, 94 with pivot pin receiving openings on flanges 96 and flange 50 provided on the fixed structure 40 and inserting a second pivot pin (not shown) through these aligned openings. The engaging member 82 pivots independently of the movable structure 42. Alternatively, a common pivot shaft may be used to mount both movable structure 42 and engaging member 82.

Engaging member 82 has a generally circular disc-shaped structure 100 with a projection 102 projecting from one side of the center thereof. The disc-shaped structure 100 has an annular sloping surface 104 surrounding the projection 102. Surface 104 and the external surface of projection 102 cooperate to provide the carrying structure engaging surface 84. The surface 104 slopes downwardly in a radial direction away from the projection 102.

The magazine assembly 14 comprises a collation carrying structure 110. In the Figures, the carrying structure 110 is illustrated as a collation container 110 that surrounds and encloses the supply of fasteners in protecting relation. However, certain aspects of the invention are not necessarily limited to a collation container and are intended to encompass any structure capable of carrying a supply of collated fasteners. The magazine assembly 14 also comprises a collation assembly 112 including a plurality of headed nails 113 spot-welded otherwise affixed at the shanks thereof to a collation structure in the form of pair of elongated flexible metal wires 114. The collation assembly 112 may alternatively be formed by embedding or adhering the nails 113 in a single plastic collation structure or adhering the nails 113 to an elongated paper strip defining the collation structure.

The container 110 is formed by coupling a first container portion 116 together with a second container portion 118. In the illustrated embodiment, the first container portion 116 comprises a cup-shaped container portion having an annular outer wall 120 with an annular flange 122 extending outwardly therefrom, an annular floor wall 124, and a post structure 126. The post structure 126 provides a first or interior surface 128 of the carrying structure with a coil locating surface 130. The post structure 126 also provides a second or exterior surface 132 opposite surface 128 with a fastener device mounting bore 134 recessed from the exterior surface 132. The bore 134 has a shape complementary to the shape of the projection 102 provided on engaging member 82. Exterior surface 132 at the portion thereof extending radially away from bore 134 has a slope complementary to the slope of surface 104 on the engaging member 82.

The second container portion 118 comprises an annular cover member that couples to the first container portion 118 to close off the container interior. The cover member 118 has an annular wall 136 that slopes upwardly from an outwardly extending flange 138 to a cup-shaped wall 140 that defines a protrusion receiving recess 142. The recess 142 has a shape complementary to the shape of the protrusion 90 on carrying structure 80.

The annular flange 122 on container portion 116 has a plurality of recessed portions 148 spaced circumferentially thereabout and the annular flange 138 on container portion 118 has a plurality of corresponding projections 149 spaced circumferentially thereabout in the same manner as recessed portions 148. These projections 149 are received in the recessed portions 148 in press-fit relation to secure the container portions 116 together. Alternatively, adhesives, clips, or mechanical fasteners may be used to effect such securement.

The container portions 116, 118 are each injection molded from a light permeable transparent or translucent plastic. This allows the user to visually verify the number of nails 113 remaining in the container 110. Alternatively only one of the two container portions 114, 116 may be made from light permeable material. Thus, the collation container 110 can be considered to have at least a collation viewing portion made from light permeable material.

To assemble the container 110, the collation assembly 112 is arranged in a wound coil. The coiled collation assembly 112 is the placed in the cup-shaped container portion 116 with the coil wrapping around the post structure 126. As a result, the coil locating surface 130 properly centers the collation assembly 112 within the container 110. Then, the cover member 118 is coupled to the cup-shaped container portion 118 to close off the top of the same.

The container 110 has an exit opening 150 that is formed in part by two spaced apart edges 152 of annular outer wall 120 of the first container portion 116, an edge 154 of floor wall 124 of the first container portion 116, and an edge 156 of the lip 138 of the second container portion 118. The edges 152 provided by the wall 120 edge on portions of the wall 120 that extend radially outwardly therefrom in an arcuate fashion. When loading the collation assembly 112 into the container portion 116, the free end of the collation assembly 112 is positioned so as to extend through the partial exit opening provided by these edgesl52, 154. Then, the second container portion 118 is coupled to the first container portion 116 as described above, thereby causing edge 156 to complete the exit opening 150, which has the free or lead end portion of the collation assembly 112 extending outwardly therefrom.

As an alternative, the first and second container portions 116, 118 may be formed integrally together in a one-shot molding operation with a living hinge joining the portions 116, 118 together. The advantage of this alternative is that container is made as one part, instead of two, thus reducing part count and simplifying manufacture/assembly.

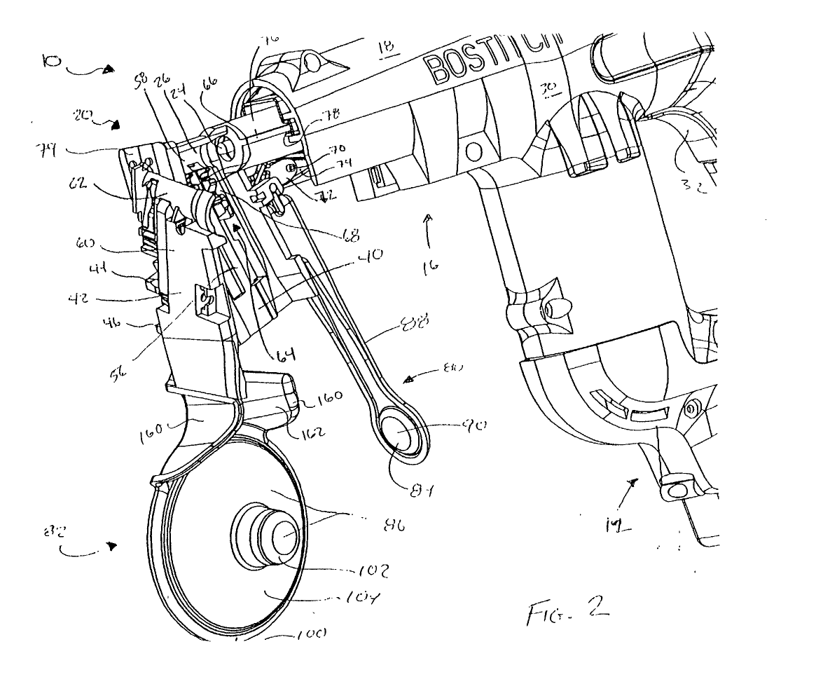

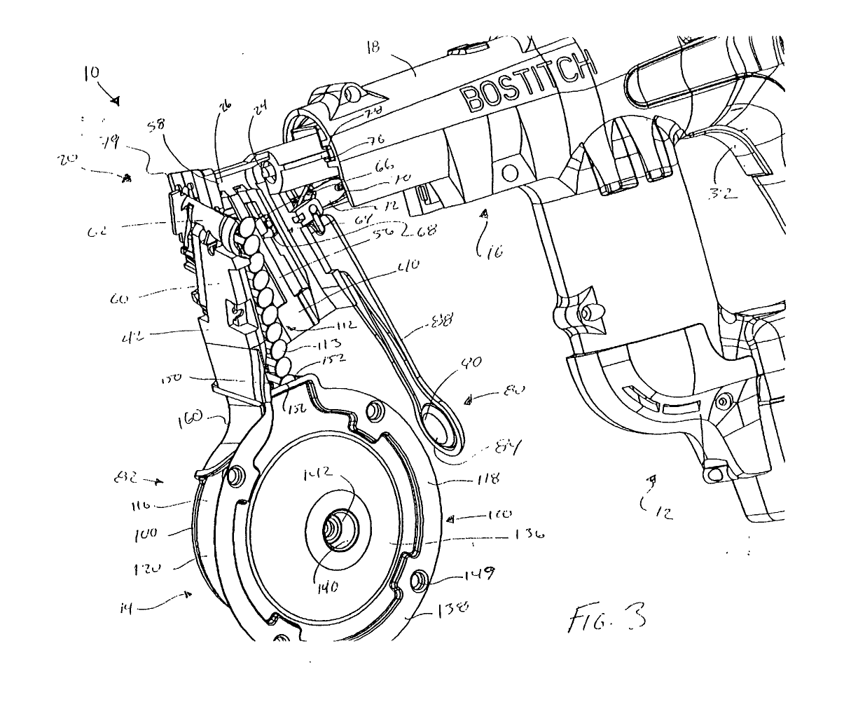

To mount the magazine assembly 14 on the fastener driving device 12, the movable structure 42 is moved to the open position thereof as shown in FIG. 2. The bore 134 of the carrying structure 110 is aligned with the projection 102 on engaging member 82 and the bore 34 is placed over the projection 102. As a result, the projection 102 is removably received within the mounting bore 134 to support the magazine assembly 14 on the engaging member 82 as shown in FIG. 3 with the surface 104 on member 82 engaging the portion of surface 132 on wall 124 extending radially from the bore 134 as shown in FIG. 6. Engaging member 82 has a pair of spaced apart container orienting portions or walls 160 formed integrally therewith. The walls 160 provide a pair of spaced apart interior container aligning surfaces 162 that face one another. When mounting the container bore 134 on the projection 102, the radially outwardly extending arcuate portions of the container wall 120 that provide the edges 152 on the sides of the exit opening 150 are received between surfaces 162 to ensure that the exit opening 150 is properly aligned with the guide track 61 for dispensing of the collation assembly 113. The surfaces 162 have arcuate shapes complementary to the shape of the arcuate container wall portions to prevent relative turning or rotating movement of the collation carrying structure 110 about the projection 102. Thus, these surfaces 162 can be considered to function both for providing proper orientation of the carrying structure 110 and the exit opening 150 thereof and for restraining relative movement of the carrying structure 110 during usage of the system 10.

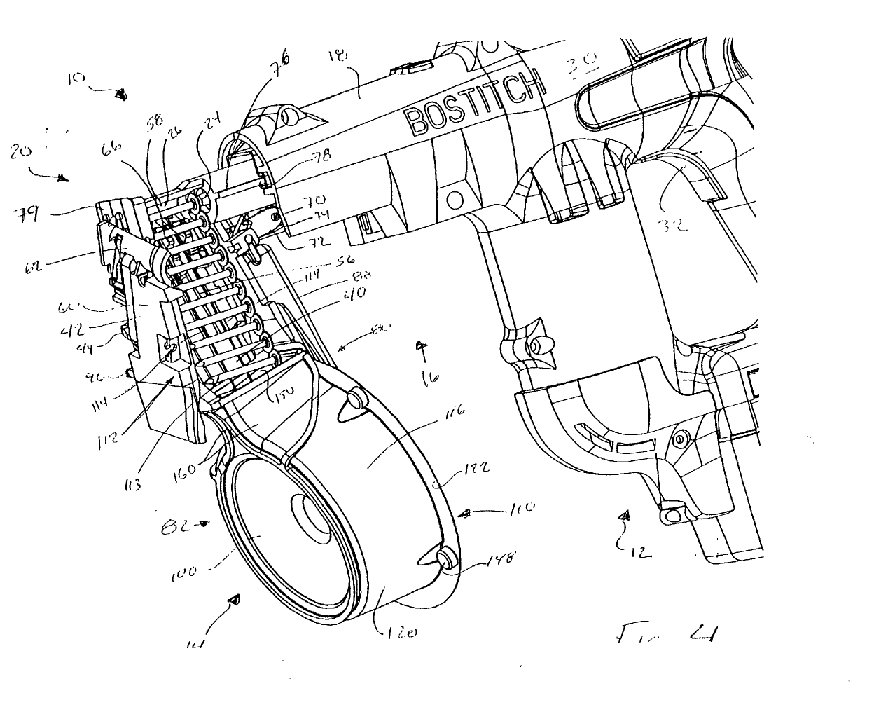

The engaging member 82 is then pivoted relative to engaging member 80 to the position shown in FIG. 4. In this position, the protrusion 90 on engaging member 80 is received within the recess 142 on the carrying structure 110. Alternatively, the protrusion 90 may be provided on the container portion 118 and the recess 142 may be provided on the engaging member 80. As a result, the carrying structure engaging members 80, 82 engage the opposing sides of the container 110 in a sandwiched magazine supporting relationship to support that same in an operative position to enable a lead fastener on the lead end portion of the collation assembly 112 to be disposed in the drive track 126. This removable mounting also allows the magazine assembly to be removed for fastener replenishment. Fastener replenishment is preferably accomplished by providing and mounting a similar magazine assembly with a fall collation assembly. In that situation, the material of the collation carrying structure 110 would be a recyclable plastic to enhance disposability. Alternatively, fastener replenishment may be accomplished by loading a new supply of collation assembly 112 into the existing collation carrying structure 1110.

After reaching the position of FIG. 4, the lead end portion of the collation assembly 112 is positioned in the drive track 26 so that the lead fastener thereof is positioned ready for impact by driver member 24. Support underneath the lead fastener is provided by the feeding structure 66. Then, the user pivots movable structure 42 about the shaft 52 to its closed position as shown in FIG. 5. The system 10 is now in a condition for fastener driving operations.

In an alternative embodiment of the invention, the collation carrying structure may be supported simply by the cooperation of bore 134 and projection 102 alone without the assistance of engaging member 80. In that embodiment, resilient fingers or the like may be provided on the projection 102 or inside the bore 102 to effect securement; however, these features are not critical to providing the invention. In another alternative embodiment, the fixed and movable engaging structures 80, 82 may omit the use of projection 102 and protrusion 90 and the sandwiched supporting relation may be provided by frictional engagement with surfaces on the opposing sides of the container 110.

It will thus be understood that the objectives of the invention have been fully and effectively accomplished. The foregoing specific embodiment is provided to illustrate the functional and structural principles of the present invention and are not intended to be limiting. To the contrary, the present invention is intended to encompass all modifications, alterations, and substitutions within the spirit and scope of the appended claims.

What is claimed:

1. A fastener driving system for driving fasteners into a workpiece, said system comprising:
(i) a fastener magazine assembly comprising:
a collation carrying structure having a post structure providing a first surface of said carrying structure with a fastener device mounting bore, said post structure providing a second surface of said carrying structure opposite said first surface with a coil locating surface;
a fastener collation assembly comprising a plurality of fasteners releasably interconnected together by collation structure, said fastener collation assembly being wound in an annular coil surrounding said coil locating surface of said post structure with a lead end portion of said collation assembly positioned to be dispensed from said carrying structure; and
(ii) a fastener driving device comprising:
a housing including an outer shell and a nose assembly,
said nose assembly providing a fastener drive track constructed and arranged to receive a lead fastener from said collation assembly;
said housing having a projection, said projection of said housing being removably receivable within said mounting bore of said collation carrying structure in a magazine supporting relationship wherein said projection and said bore cooperate to removably support said carrying structure in an operative position to enable a lead fastener carried on said lead end portion of said fastener collation assembly to be disposed in said drive track and to enable said magazine assembly to be removed for fastener replenishment;
a driver member mounted for movement along said drive track through a drive stroke wherein said driver member impacts the lead fastener received in said drive track and drives the lead fastener outwardly from said drive track into the workpiece and a return stroke opposite said drive stroke;
a power drive assembly operatively connected to said driver member, said power drive assembly being constructed and arranged to move said driver member under power through said drive stroke thereof; and
a feed mechanism having feeding structure constructed and arranged to engage said collation assembly, said feeding mechanism being constructed and arranged to move said feeding structure so as to move said collation assembly in a feeding direction to feed a subsequent lead fastener into said drive track after said driving member has impacted and driven the aforesaid lead fastener into the workpiece.

2. A fastener driving system according to claim 1, wherein said collation carrying structure comprises:
a first container portion,
a second container portion, said first and second container portions being coupled together to form a collation container having an interior annular collation receiving space,
said first surface of said carrying structure being an exterior surface of said container and said second surface of said carrying structure being an interior surface of said container, said post structure extending inwardly into said collation receiving space,
said collation container having an exit opening that opens outwardly from said collation receiving space,
said fastener collation assembly being disposed in the collation receiving space of said container with a lead end portion of said collation assembly extending outwardly from said exit opening to enable said collation assembly to be dispensed from said container.

3. A fastener driving system according to claim 2, wherein said fastener driving device further comprises:
a first carrying structure engaging member providing said projection;
a second carrying structure engaging member having a carrying structure engaging surface, said first and second carrying structure engaging members being movable relative to one another between (a) a supporting position wherein said projection is removably received in said bore of said carrying structure and said carrying structure engaging surface of said second carrying structure engaging member removably engages a side of said carrying structure opposite said bore in a sandwiched magazine supporting relationship wherein said first and second carrying structure engaging members cooperate to removably support said carrying structure in an operative position to enable a lead fastener carried on said lead end portion of said fastener collation assembly to be disposed in said drive track and (b) a releasing position wherein said first and second carrying structure engaging members are moved out of said supporting position to enable said magazine assembly to be removed for fastener replenishment.

4. A fastener driving system according to claim 3, wherein said side of said carrying structure opposite said bore has one of a protrusion and a recess and wherein the second carrying structure engaging surface of said second carrying structure engaging member has the other of said protrusion and said recess, said protrusion being configured to be removably received within said recess when said carrying structure engaging members are in said supporting position thereof.

5. A fastener driving system according to claim 2, wherein said first and second container portions are integrally formed together and joined by a living hinge.

6. A magazine assembly for use with a fastener driving device comprising a housing including an outer shell and a nose assembly; said nose assembly providing a fastener drive track constructed and arranged to receive a lead fastener; said housing having a projection; a driver member mounted for movement along said drive track through a drive stroke wherein said driver member impacts the lead fastener received in said drive track and drives the lead fastener outwardly from said drive track into the workpiece and a return stroke opposite said drive stroke; a power drive assembly operatively connected to said driver member, said power drive assembly being constructed and arranged to move said driver member under power through said drive stroke thereof; and a feed mechanism having feeding structure constructed and arranged to engage a collation assembly, said feeding mechanism being constructed and arranged to move said feeding structure so as to move said collation assembly in a feeding direction to feed a subsequent lead fastener into said drive track after said driving member has impacted and driven the aforesaid lead fastener into the workpiece; said magazine assembly comprising:
a collation carrying structure having a post structure providing a first surface of said carrying structure with a fastener device mounting bore, said post structure providing a second surface of said carrying structure opposite said first surface with a coil locating surface; and
a fastener collation assembly comprising a plurality of fasteners releasably interconnected together by collation structure, said fastener collation assembly being wound in an annular coil surrounding said coil locating surface of said post structure with a lead end portion of said collation assembly positioned to be dispensed from said carrying structure;
said mounting bore of said collation carrying structure being configured such that said projection of said housing can be removably received within said bore in a magazine supporting relationship wherein said projection and said bore cooperate to removably support said carrying structure in an operative position to enable a lead fastener carried on said lead end portion of said fastener collation assembly to be disposed in said drive track and to enable said magazine assembly to be removed for fastener replenishment.

7. A magazine assembly according to claim 6, wherein said collation carrying structure comprises:
a first container portion,
a second container portion, said first and second container portions being coupled together to form a collation container having an interior annular collation receiving space,
said first surface of said carrying structure being an exterior surface of said container and said second surface of said carrying structure being an interior surface of said container, said post structure extending inwardly into said collation receiving space,
said collation container having an exit opening that opens outwardly from said collation receiving space,
said fastener collation assembly being disposed in the collation receiving space of said container with a lead end portion of said collation assembly extending outwardly from said exit opening to enable said collation assembly to be dispensed from said container.

8. A magazine assembly according to claim 7, wherein said first and second container portions are integrally formed together and joined by a living hinge.

9. A fastener driving system for driving fasteners into a workpiece, said system comprising:
(i) a fastener magazine assembly comprising:
a collation carrying structure;
a fastener collation assembly comprising a plurality of fasteners releasably interconnected together by collation structure, said fastener collation assembly being carried by said carrying structure with a lead end portion of said collation assembly positioned to enable said collation assembly to be dispensed from said carrying structure; and
(ii) a fastener driving device comprising:
a housing including an outer shell and a nose assembly,
said nose assembly providing a fastener drive track constructed and arranged to receive a lead fastener from said collation assembly;
a first carrying structure engaging member having a first carrying structure engaging surface,
a second carrying structure engaging member having a second carrying structure engaging surface, said first and second carrying structure engaging members being movable relative to one another between (a) a supporting position wherein said respective first and second carrying structure engaging surfaces of said carrying structure engaging members removably engage opposing sides of said carrying structure in a sandwiched magazine supporting relationship wherein said first and second carrying structure engaging members cooperate to removably support said carrying structure between said engaging surfaces thereof in an operative position to enable a lead fastener carried on said lead end portion of said fastener collation assembly to be disposed in said drive track and (b) a releasing position wherein said first and second carrying structure engaging members are moved out of said supporting position to enable said magazine assembly to be removed for fastener replenishment;
a driver member mounted for movement along said drive track through a drive stroke wherein said driver member impacts the lead fastener received in said drive track and drives the lead fastener outwardly from said drive track into the workpiece and a return stroke opposite said drive stroke;
a power drive assembly operatively connected to said driver member, said power drive assembly being constructed and arranged to move said driver member under power through said drive stroke thereof; and
a feed mechanism having feeding structure constructed and arranged to engage said collation assembly, said feeding mechanism being constructed and arranged to move said feeding structure so as to move said collation assembly in a feeding direction to feed a subsequent lead fastener into said drive track after said driving member has impacted and driven the aforesaid lead fastener into the workpiece.

10. A fastener driving system according to claim 9, wherein said first carrying structure engaging member is fixed on said housing and wherein said second carrying structure engaging member is movable relative to said first carrying structure engaging member.

11. A fastener driving system according to claim 9, wherein said collation carrying structure has a post structure providing a first surface of said carrying structure with a fastener device mounting bore, said post structure providing a second surface of said carrying structure opposite said first surface with a coil locating surface; and wherein said fastener collation assembly is wound in an annular coil surrounding said coil locating surface of said post structure with a lead end portion of said collation assembly positioned to be dispensed from said carrying structure;
said housing having a projection, said projection of said housing being removably receivable within said mounting bore of said collation carrying structure in a cooperating magazine supporting relationship wherein said projection and said bore cooperate to removably support said carrying structure in an operative position to enable a lead fastener carried on said lead end portion of said fastener collation assembly to be disposed in said drive track and to enable said magazine assembly to be removed for fastener replenishment.

12. A fastener driving system according to claim 9, wherein said collation carrying structure comprises:
a first container portion,
a second container portion, said first and second container portions being coupled together to form a collation container having an interior annular collation receiving space,
said collation container having an exit opening that opens outwardly from said collation receiving space,
said fastener collation assembly being disposed in the collation receiving space of said container with a lead end portion of said collation assembly extending outwardly from said exit opening to enable said collation assembly to be dispensed from said container.

13. A fastener driving system according to claim 12, wherein said first and second container portions are integrally formed and joined together by a living hinge.

14. A fastener driving system for driving fasteners into a workpiece, said system comprising:
(i) a fastener magazine assembly comprising:
a first container portion,
a second container portion, said first and second container portions being coupled together to form a collation container enclosing an interior annular collation receiving space, said collation container having a collation viewing portion thereof formed from a light permeable material through which a user can view said interior annular collation receiving space, said collation container having an exit opening that opens outwardly from said collation receiving space,
a fastener collation assembly comprising a plurality of fasteners releasably interconnected together by collation structure, said fastener collation assembly being disposed in the collation receiving space of said container with a lead end portion of said collation assembly extending outwardly from said exit opening to enable said collation assembly to be dispensed from said container, said fastener collation assembly being positioned with respect to said collation viewing portion of said container such that the user can view said collation assembly to visually ascertain an amount of said collation assembly remaining in said container; and
(ii) a fastener driving device comprising:
a housing including an outer shell and a nose assembly,
said nose assembly providing a fastener drive track constructed and arranged to receive a lead fastener from said collation assembly;
a container supporting structure, said collation container being removably engageable with said container supporting structure in a magazine supporting relationship wherein said supporting structure and said container cooperate to removably support said container in an operative position to enable a lead fastener carried on said lead end portion of said fastener collation assembly to be disposed in said drive track and to enable said magazine assembly to be removed for fastener replenishment;
a driver member mounted for movement along said drive track through a drive stroke wherein said driver member impacts the lead fastener received in said drive track and drives the lead fastener outwardly from said drive track into the workpiece and a return stroke opposite said drive stroke;
a power drive assembly operatively connected to said driver member, said power drive assembly being constructed and arranged to move said driver member under power through said drive stroke thereof; and
a feed mechanism having feeding structure constructed and arranged to engage said collation assembly, said feeding mechanism being constructed and arranged to move said feeding structure so as to move said collation assembly in a feeding direction to feed a subsequent lead fastener into said drive track after said driving member has impacted and driven the aforesaid lead fastener into the workpiece.

15. A fastener driving system according to claim 14, wherein said first portion provides said collation viewing portion and wherein said first portion is entirely made from said light permeable material.

16. A fastener driving system according to claim 15, wherein said second portion also provides said collation viewing portion and wherein said second portion is entirely made from said light permeable material.

17. A fastener driving system according to claim 16, wherein said container is entirely made from said light permeable material.

18. A fastener driving system according to claim 14, wherein said first and second container portions are integrally formed together and joined by a living hinge.

19. A magazine assembly for use with a fastener driving device comprising a housing including an outer shell and a nose assembly; said nose assembly providing a fastener drive track constructed and arranged to receive a lead fastener from said collation assembly; a container supporting structure; a driver member mounted for movement along said drive track through a drive stroke wherein said driver member impacts the lead fastener received in said drive track and drives the lead fastener outwardly from said drive track into the workpiece and a return stroke opposite said drive stroke; a power drive assembly operatively connected to said driver member, said power drive assembly being constructed and arranged to move said driver member under power through said drive stroke thereof; and a feed mechanism having feeding structure constructed and arranged to engage a collation assembly, said feeding mechanism being constructed and arranged to move said feeding structure so as to move said collation assembly in a feeding direction to feed a subsequent lead fastener into said drive track after said driving member has impacted and driven the aforesaid lead fastener into the workpiece; said magazine assembly comprising:
a first container portion,
a second container portion, said first and second container portions being coupled together to form an enclosed collation container having an interior annular collation receiving space, said collation container having a collation viewing portion thereof formed from a light permeable material through which a user can view said interior annular collation receiving space, said collation container having an exit opening that opens outwardly from said collation receiving space,
a fastener collation assembly comprising a plurality of fasteners releasably interconnected together by collation structure, said fastener collation assembly being disposed in the collation receiving space of said container with a lead end portion of said collation assembly extending outwardly from said exit opening to enable said collation assembly to be dispensed from said container, said fastener collation assembly being positioned with respect to said collation viewing portion of said container such that the user can view said collation assembly to visually ascertain an amount of said collation assembly remaining in said container,
said collation container being removably engageable with said container supporting structure in a cooperating magazine supporting relationship wherein said supporting structure and said container cooperate to removably support said container in an operative position to enable a lead fastener carried on said lead end portion of said fastener collation assembly to be disposed in said drive track and to enable said magazine assembly to be removed for fastener replenishment.

20. A magazine assembly according to claim 19, wherein said first portion provides said collation viewing portion and wherein said first portion is entirely made from said light permeable material.

21. A magazine assembly according to claim 20, wherein said second portion also provides said collation viewing portion and wherein said second portion is entirely made from said light permeable material.

22. A magazine assembly according to claim 21, wherein said container is entirely made from said light permeable material.

23. A magazine assembly according to claim 19, wherein said first and second container portions are integrally formed together and joined by a living hinge.
